(19) United States
(12) Patent Application Publication
(10) Pub. No.: US 2025/0277383 A1
(43) Pub. Date: Sep. 4, 2025

(54) Rafter Square Comprising a Heel Having an Integrated Tool Aperture

(71) Applicant: Sven Kysar, Yacolt, WA (US)

(72) Inventor: Sven Kysar, Yacolt, WA (US)

(21) Appl. No.: 18/592,823

(22) Filed: Mar. 1, 2024

(51) Int. Cl. E04G 21/18; G01B 3/56

(52) U.S. Cl. CPC E04G 21/1891; G01B 3/566

(57) ABSTRACT

A rafter square having an integrated tool aperture is disclosed. A tool aperture is formed in the heel of a rafter square which may be used to loosen or tight bolts in a tool such as on a circular saw for example. The heel may have a single, hexagonally shaped aperture to accommodate a hex bolt commonly found on circular saws in an embodiment. The tool aperture may be shaped in an elongated, stepped shape to accommodate multiple sizes of bolts.

### BACKGROUND OF THE INVENTION

### 1. Field of the Invention

The present invention relates in general to rafter squares used in construction of homes and other structures to determine and mark cut angles for rafters and the like. More particularly, the present invention is directed to rafter squares having a heel with an integrated tool aperture adapted for loosening and tightening mechanical fasteners.

### 2. Description of the Related Art

A rafter square is a multi-functional tool used for marking out cut lines on dimensional lumber, and can be used for framing a house, marking out and cutting rafters, and marking out and making cuts for decks and fences. As a result of their versatility, many carpenters and construction workers keep rafter squares on hand as part of their tools they take to the jobsite. In fact, many carpenters keep their rafter squares with them in their tool belts.

Carpenters who mark out and cut lines on dimensional lumber at a jobsite typically use a circular saw as well. Often, carpenters may have to replace a circular saw blade at the jobsite. Circular saw blades are replaced by using a wrench to engage with and loosen the hex bolt that secures the circular saw blade to the circular saw. However, this process may be time consuming for carpenters as they may have to leave the area of the jobsite in which they were working and walk to a remote area to find a proper wrench.

Accordingly, a need exists to provide rafter squares having multiple functions to allow carpenters to loosen and tighten bolts for circular or table saws at a jobsite.

### SUMMARY OF THE INVENTION

In the first aspect, a rafter square is disclosed. The rafter square comprises an isosceles right triangular-shaped blade having a base side, a perpendicular side perpendicular to the base side, and a hypotenuse side that defines the hypotenuse between the base side and the perpendicular side. The blade has a plurality of threaded holes formed internally in the blade, each threaded hole having an opening at the base side of the blade.

The rafter square further comprises a heel of generally parallelepiped shape with an elongated body having a top face, a bottom face, a front edge, a back edge, and two side edges. The heel is coupled to the blade forming a right angle between the blade and the heel, the heel having one or more through-hole aperture for engaging with a fastening mechanism. The heel has a plurality of fastener through-holes positioned to align with the plurality of threaded holes of the blade when blade is attached to the heel.

The rafter square further comprises a plurality of fasteners for releasably attaching the heel to the blade where the top face is positioned immediately adjacent to base side of the blade, each fastener placed through each of the fastener through-holes of the heel and the corresponding threaded hole formed in the blade.

In a first preferred embodiment, the one or more through-hole apertures comprises a hexagonal-shaped aperture sized to releasable receive and engage with a hexagonal bolt. The aperture is preferably located on the heel proximal to the back edge of the heel. The one or more through-hole apertures preferably comprises an elongated and stepped aperture that provides multiple sized wrench apertures for use with different sized bolts. The one or more through-hole apertures preferably comprises a plurality of discrete apertures spaced apart on the heel. The blade preferably further comprises a blade notch positioned immediately above the aperture in the heel for receiving the head of the fastening mechanism. The rafter square is preferably sized to enable the engagement of a bolt securing a circular saw blade to a circular saw. The heel is preferably coupled to the blade via a plurality of fastening screws.

In a second aspect, a rafter square is disclosed. The rafter square comprises a triangular-shaped blade having a base side, a perpendicular side perpendicular to the base side, and a hypotenuse side that define the hypotenuse between the base side and the perpendicular side, and a heel of generally parallelepiped shape with an elongated body having a top face, a bottom face, a front edge, a back edge, and two side edges, the heel coupled to the blade forming a right angle between the blade and the heel, the heel having one or more through-hole apertures for engaging with a fastening mechanism.

In a second preferred embodiment, the one or more through-hole apertures comprises a hexagonal-shaped aperture sized to releasable receive and engage with a hexagonal bolt. The aperture is preferably located on the heel proximal to the vertex of the blade opposite the hypotenuse side. The one or more through-hole apertures preferably comprises an elongated and stepped aperture that provides multiple sized wrench apertures for use with different sized bolts. The one or more through-hole apertures preferably comprises a plurality of apertures spaced apart on the heel. The blade further preferably comprises a blade notch positioned immediately above the aperture in the heel for receiving the head of the fastening mechanism. The heel is preferably coupled to the blade via a plurality of fastening screws. The blade is preferably formed as a single piece. The rafter square preferably further comprises a level vial aligned parallel with the length of the heel providing visual indication of whether the rafter square is level.

In a third aspect, a rafter square is disclosed. The rafter square comprises a blade, and a heel of generally parallelepiped shape with an elongated body having a top face, a bottom face, a front edge, a back edge, and two side edges, the heel coupled to the blade forming a right angle between the blade and the heel, the heel having one or more through-hole apertures for engaging with a fastening mechanism.

In a third preferred embodiment, the one or more through-hole apertures comprises a hexagonal-shaped aperture sized to releasable receive and engage with a hexagonal bolt. The one or more through-hole apertures preferably comprises an elongated and stepped aperture that provides multiple sized wrench apertures for use with different sized bolts.

These and other features and advantages of the invention will become more apparent with a description of preferred embodiments in reference to the associated drawings.

### DESCRIPTION OF THE DRAWINGS

FIG. 1 is a perspective, exploded view showing a two-piece, rafter square having an integrated tool aperture in one or more embodiments.

FIG. 2 is a perspective view of the two-piece rafter square.

FIG. 3 is a perspective view of a rafter square having a level vial.

FIG. 4 is a perspective view of a one-piece rafter square in one or more embodiments.

FIG. 5 is a perspective view of the bottom of a one-piece rafter square having an aperture for accommodating multiple hexagonally shaped bolts.

FIG. 6 is a bottom view of a heel showing a single hexagonal aperture.

FIG. 7 is a bottom view of a heel showing an elongated, stepped, hexagonal aperture for accommodating multiple bolt sizes.

FIG. 8 is a bottom view of a heel showing multiple, discrete, hexagonal apertures spaced along the heel.

FIG. 9 is a perspective view of a rafter square having an aperture engaging with a bolt on a circular saw in one or more embodiments.

FIG. 10 is a perspective view of a rafter square having an aperture engaging with a bolt on for a generic tool or structure in one or more embodiments.

### DETAILED DESCRIPTION OF THE PREFERRED EMBODIMENTS

Carpenters commonly will use a rafter square hand-in-hand with a circular saw, and often alternate between the use of the rafter square and the circular saw many times over the course of framing a house or laying out and cutting rafters. Carpenters frequently replace circular saw blades at the jobsite, such as to replace worn or damaged saw blades, or to replace saw blades with another type of saw blades having a different number of cutting teeth for finer or more aggressive cuts.

In order to replace a circular saw blade, carpenters conventionally will need to find the wrench for the size and shape of the bolt on the circular saw. In practice, this may require carpenters to leave the area at the jobsite in which they were working to find the correct wrench. In other cases, carpenters may have simply forgotten to bring their wrenches or encounter an unexpected bolt on a structure other than a circular saw that needs to be tightened. Alternatively, carpenters may carry the correct wrench in their toolbelts, but this practice can clutter a tool belt and make the tool belt more cumbersome.

In an embodiment, a rafter square having an integrated tool aperture (i.e., one or more through-hole apertures) is contemplated. The tool aperture is sized to receive and engage with a fastening mechanism such as bolts used in circular saws. A carpenter no longer needs to search for correct wrenches to remove or tighten circular saw bolts. Instead, carpenters simply reach for their rafter squares, a tool that they already carry, and use the tool aperture feature of the rafter square to remove or tighten the circular saw bolt. Hence having a tool aperture integrated into a rafter square saves time over the course of the construction project.

In addition, a rafter square with an integrated tool aperture may be useful when carpenters unexpectedly encounter bolts in structures or tools other than circular saws at jobsites which need to be tightened or loosened, and the carpenters do not have the proper wrenches in their possession. As most carpenters always carry rafter squares, they may simply use the rafter square to tighten or loosen bolts.

In an embodiment, the rafter square comprises a triangular-shaped blade, usually having cutout regions and markings indicating lengths and angles, and a heel that is attached to the bottom and extends beyond blade to form a “lip” or “fence” which can be placed against dimensional lumber to align the rafter square.

In an embodiment, a tool aperture is formed in the heel which a carpenter may use to loosen or tight bolts in a tool such as on a circular saw for example. In one or more embodiments, the heel may have a single, hexagonally shaped aperture to accommodate a hex bolt commonly found on circular saws in an embodiment. In an embodiment, the tool aperture may be shaped to engage with multiple sized bolts, such as in an elongated, stepped shape.

While embodiments described herein refer to specific examples such as circular saws or hexagonally shaped bolts (i.e., fastening mechanism), it shall be understood that the examples discussed and illustrated herein are for exemplary purposes only, and that other type of fastening mechanisms and other tools or structures which may benefit from embodiments described herein are contemplated in one or more embodiments.

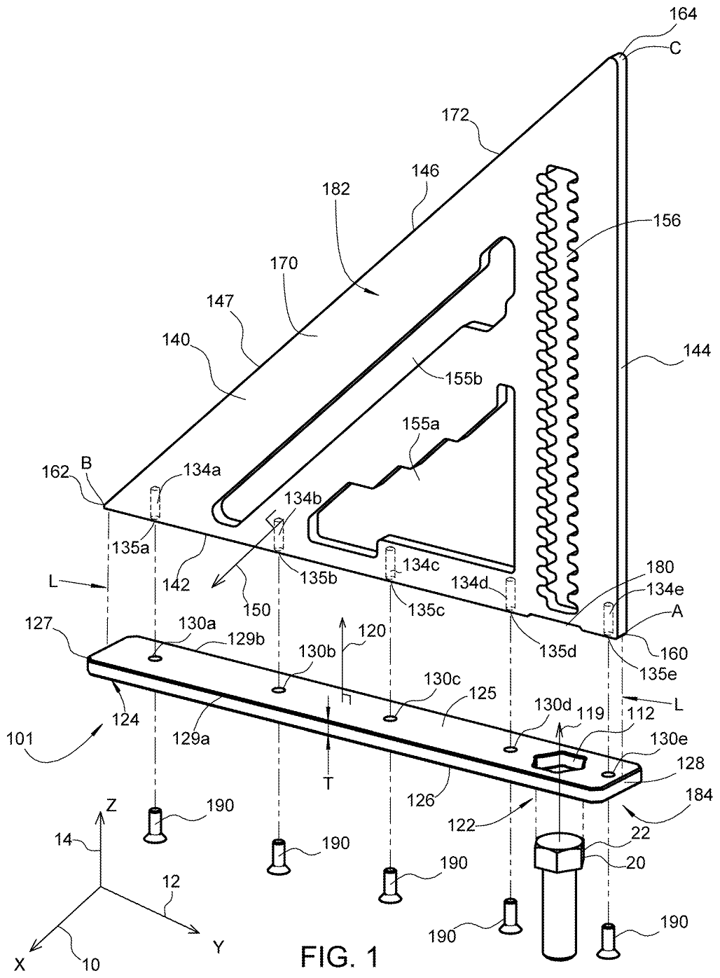

FIG. 1 is a perspective, exploded view showing a two-piece, rafter square 101 in one or more embodiments. A right-handed coordinate system having mutually orthogonal x axis 10, a y axis 12, and a z axis 14 is also shown for reference.

A rafter square 101 comprises an isosceles right triangle shaped blade 140 and a heel 110. The isosceles right triangle blade 140 has three vertices. The first vertex is labeled as vertex 160 (also labeled as “A”), the second vertex is labeled as vertex 162 (also labeled as “B”), and the third vertex is labeled as vertex 164 (also labeled as “C”). The vertex 160 may be referred to as the “pivot point” where the user can mark angles other than 90 degrees by pivoting the rafter square 101 relative to dimensional lumber. The angle formed by ∠CAB is 90 degrees forming a right angle, the angle formed by ∠ABC is 45 degrees, and the angle formed by ∠BCA is 45 degrees such that triangle ABC is an isosceles right triangle.

The isosceles right triangular shaped blade 140 has a base side 142 (formed by line segment AB parallel with the y axis 12), a perpendicular side 144 (formed by line segment AC parallel with the z direction 14) perpendicular to the base side 142, and a hypotenuse side 146 (formed by line segment CB) that defines the hypotenuse 147 between the base side 142 and the perpendicular side 144. The base side 142 and the perpendicular side 144 have a length “L.” The blade 140 has a top surface 170 and a bottom surface 172. The blade 140 may have a plurality of cutout sections and length or angle indicia 182 such as a cutout 155a, a diagonal slot 155b, and a vertical slot 156 for example.

In an embodiment, a heel 110 has a generally parallelepiped, rectangular shape with an elongated body also having a length “L” parallel with the y axis 12. The heel 110 has a top face 125, a bottom face 126, a front edge 127, a back edge 128, and two side edges 129a and 129b.

In an embodiment, the heel 110 is configured to be releasable attached to the blade 140, so that the heel 110 may be interchangeable with other types of heels 110. As shown in FIG. 1, the blade 140 has a plurality of threaded holes 134a, 134b, 134c, 135d, and 135e formed internally in the blade 140 where each threaded hole 134a-134e has a corresponding opening 135a, 135b, 135c, 135d, and 135e at the base side 142 of the blade 140. The heel 110 has a plurality of fastener through-holes 130a, 130b, 130c, 130d, and 130e positioned to align with the plurality of threaded holes 134a-134e of the blade 140 when blade 140 is attached to the heel 110.

A plurality of fasteners 190 are employed to releasably attach the heel 110 to the blade 140. When the top face 125 of the heel 110 is positioned immediately adjacent to base side 142 of the blade 140, each fastener 190 is placed through each of the fastener through-holes 130a-130e of the heel 110 and are threaded into the corresponding threaded holes 134a-134e formed in the blade 140. In other words, a first fastener 190 is placed through the fastener through hole 130a and into threaded hole 134a, a second fastener 190 is placed through hole 130b and into threaded hole 134b, a third fastener 190 is placed through hole 130c and into threaded hole 134c, a fourth fastener 190 is placed through hole 130d and into threaded hole 134d, and a fifth fastener 190 is placed through hole 130e and into threaded hole 134e.

When the heel 110 is attached to the blade 140, a right angle is formed between the blade 140 and the heel 110. As shown, the normal 150 for the blade is parallel with the x axis 10, and the normal 120 of the heel 110 and the center line 119 of the normal of the aperture 112 is parallel with the z axis.

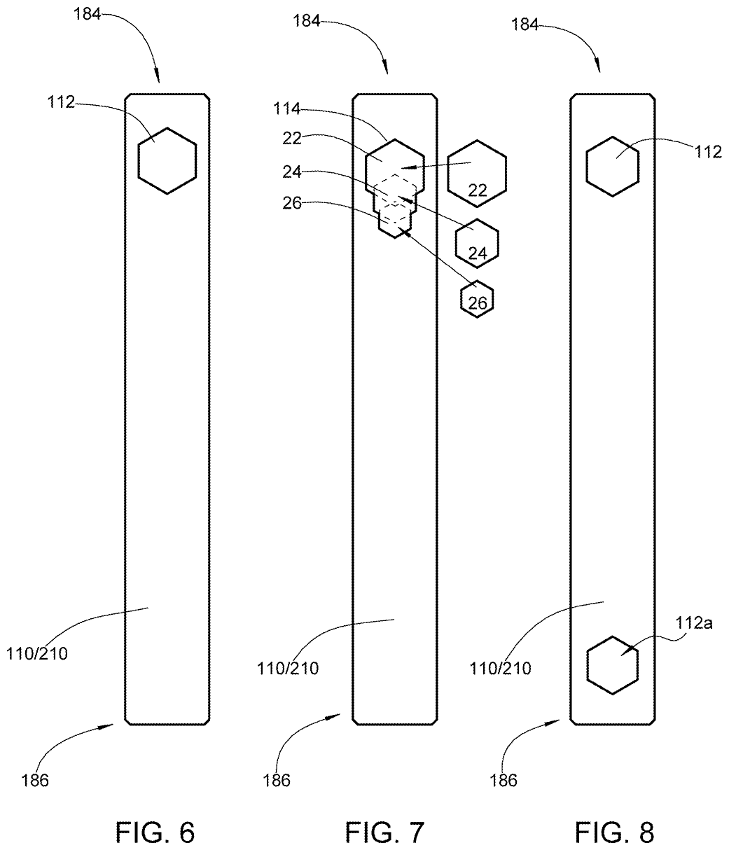

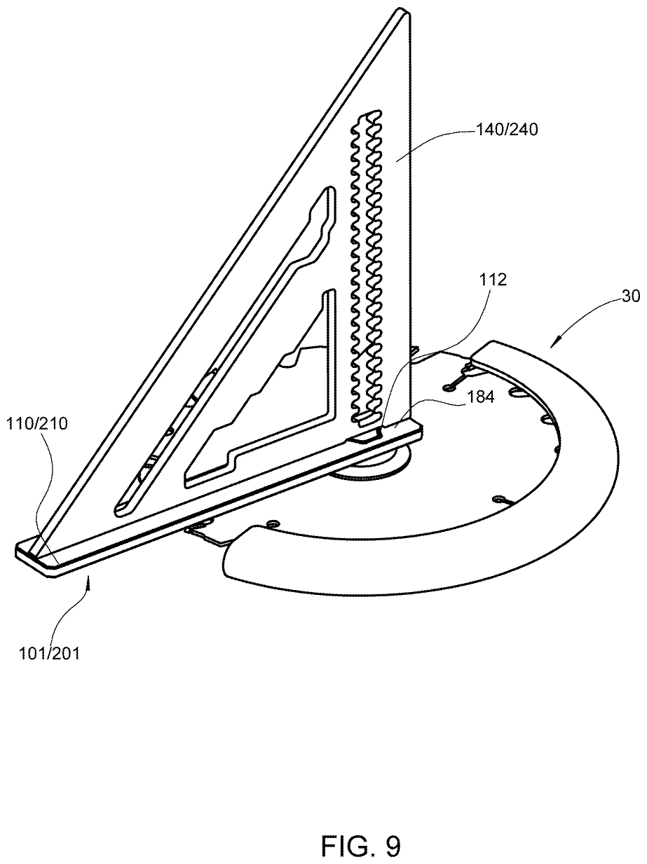

The heel 110 has a through-hole aperture 112 for engaging with a fastening mechanism 20, which refers to a hexagonal bolt 20 for example. In an embodiment, the through-hole aperture 112 may be sized and shaped to receive and engage with a bolt 20 having a hexagonal head 22 that may be employed in a circular saw 30 for example (See FIGS. 6 and 9). The aperture 112 Is a closed-end or box-end where the aperture 112 is placed around the bolt head 22 to completely encompass and surround the bolt 20.

In an embodiment, the blade 140 further comprises a blade notch 180 positioned immediately above the aperture 112 in the heel 110 for receiving the bolt head 22 of the bolt 20 when the heel 110 is attached to the blade 140. A blade notch 180 may provide additional clearance for the bolt head 22 of the bolt 20, particularly when the thickness of the heel 110 “T” is less than the height of the bolt head 22.

In an embodiment, the aperture 112 is located on the heel 110 proximal 122 to the back edge 128 of the heel 110. When the rafter square 101 is assembled, the aperture 112 is positioned near the vertex 160 of the blade 240 opposite the hypotenuse side 146, which may provide greater structural support to the blade 140 when a user is attempting to tighten or loosen a bolt 20.

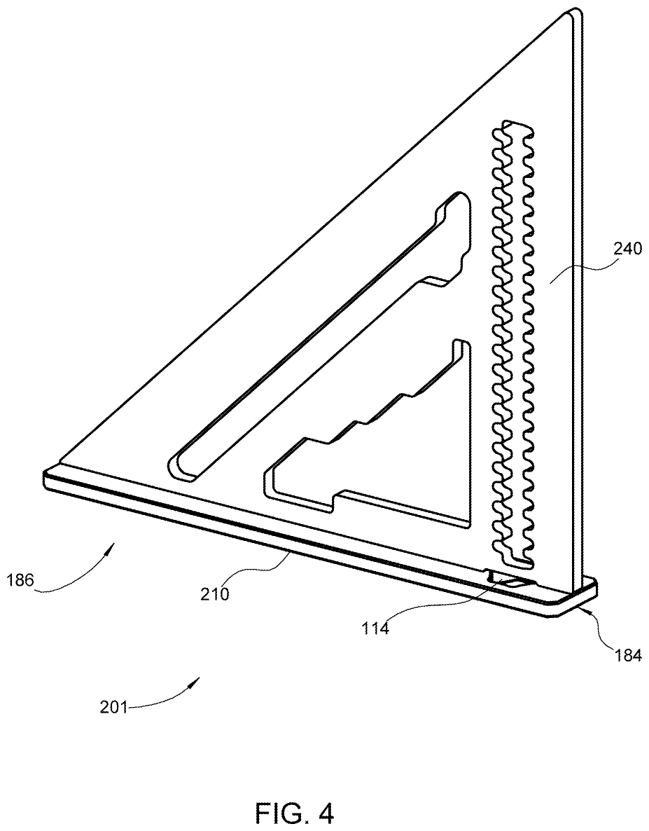

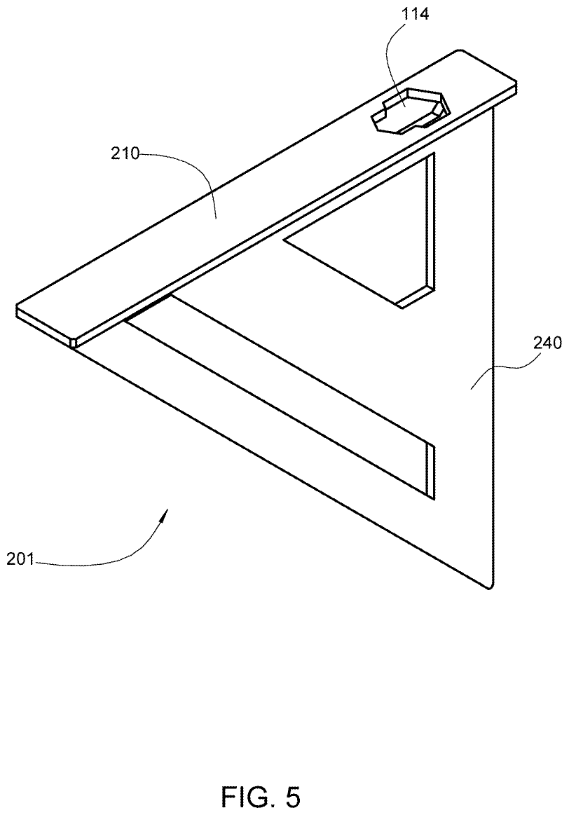

In other words, in an embodiment, a rafter square 101 comprises a triangular-shaped blade 140 and a heel 110. The triangular-shaped blade 140 has a base side 142, a perpendicular side 144 perpendicular to the base side 142, and a hypotenuse side 146 that define the hypotenuse 147 between the base side 142 and the perpendicular side 144. The heel 110 is of generally parallelepiped shape with an elongated body having a top face 125, a bottom face, a front edge 126, a back edge 127, and two side edges 129a and 129b, the heel coupled to the blade forming a right angle between the blade and the heel, the heel 110 having one or more through-hole apertures 112 for engaging with a fastening mechanism 20 (i.e., hexagonal bolt 20 for example). In an embodiment, the heel 210 and the blade 240 are formed as a single piece 201 (See FIGS. 4 and 5).

Stated in yet other words, in an embodiment, a rafter square 101 comprises a blade 140, and a heel 110 of generally parallelepiped shape with an elongated body having a top face 125, a bottom face, a front edge 126, a back edge 127, and two side edges 129a and 129b, the heel coupled to the blade forming a right angle between the blade and the heel, the heel 110 having one or more through-hole apertures 112 for engaging with a fastening mechanism 20 (i.e., hexagonal bolt 20 for example).

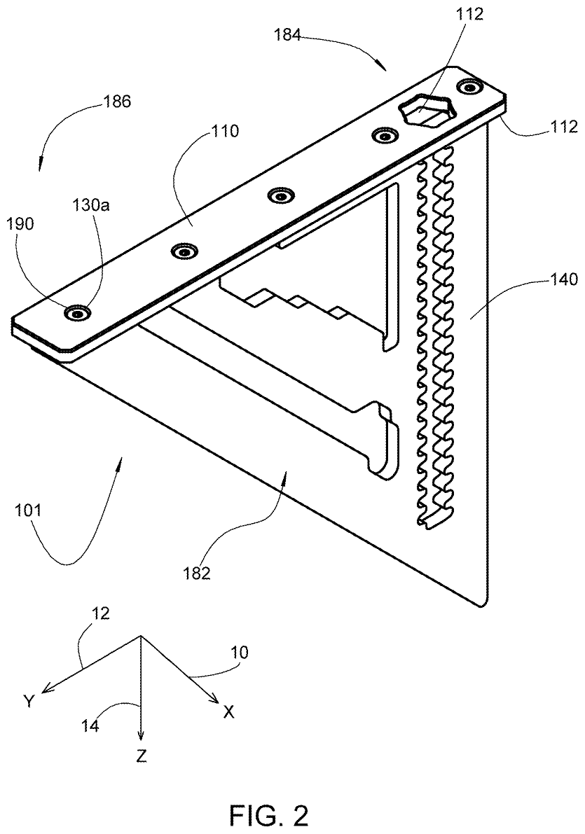

FIG. 2 is a bottom, perspective view of the two-piece rafter square 101 having a single tool aperture 112, where the heel 110 is attached to the blade 140 using the mechanical fasteners 190 such as screws placed through hole 130a. FIG. 2 also illustrates the region proximal 184 to the vertex 160 and the region distal 186 from the vertex 160.

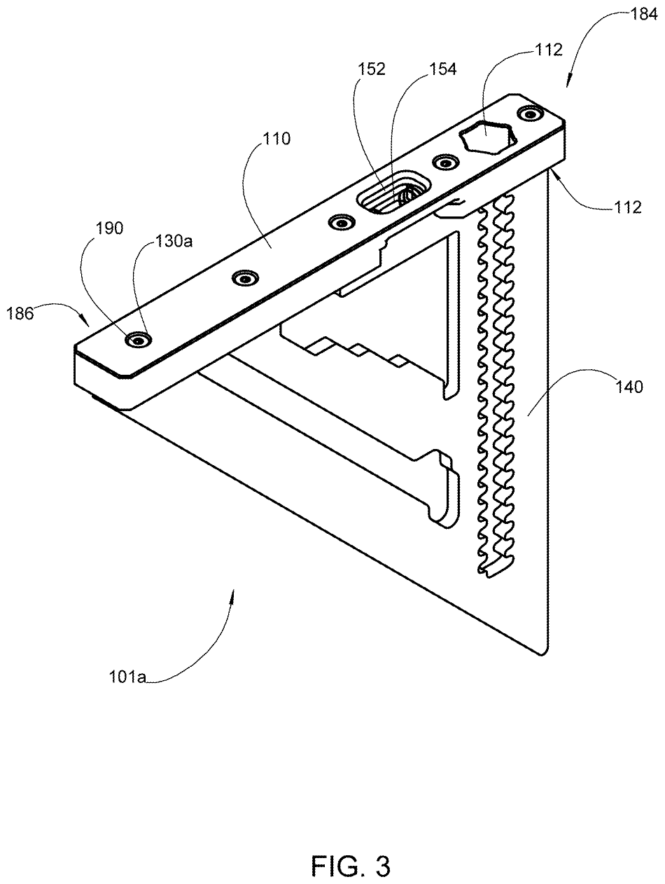

FIG. 3 is a bottom, perspective view of a rafter square 101a having a level vial 154. A level vial window 152 is formed in the heel 110 to facilitate visibility of the level vial 154 during use.

FIG. 4 is a side, perspective view of a one-piece rafter square 201 in one or more embodiments. The rafter square 201 comprises a heel 210 and a blade 240 which are formed in one piece. Aperture 114 is formed onto heel 210. FIG. 5 is a bottom, perspective view of a one-piece rafter square 201 having an aperture 114 accommodating multiple hexagonally shaped bolts.

FIGS. 6-8 illustrate the various shapes of through-hole apertures 112, 112a and 114. FIG. 6 is a bottom view of a heel 110/210 showing a single hexagonal through-hole aperture 112. The through-hole aperture 112 may be sized and shaped to receive and engage with a bolt 20 having a hexagonal bolt head 22 that may be employed in a circular saw 30 for example. The aperture 112 Is a closed-end or box-end where the aperture 112 is placed around the bolt head 22 to completely encompass and surround the bolt head 22. In an embodiment, the aperture 112 is positioned proximal to the pivot point 160.

FIG. 7 is a bottom view of a heel showing an elongated, stepped, hexagonal aperture 114 for accommodating multiple bolt sizes, such as ⅝-inch, 9/16-inch, or ½-inch bolts for example. In an exemplary embodiment shown in FIG. 7, the heel 110/210 has a through-hole aperture 114 for engaging with a plurality of bolts of differing sizes of bolt heads such as bolt head 22, bolt head 24, and bolt head 26 for example. The aperture 114 is similar to a closed-end or box-end wrench, where the aperture 114 is placed around the bolt head 22, 24, or 26 to receive the bolt head 22, 24, 26 and to completely encompass and surround the all of the bolt heads 22, 24, or 26. Aperture 114 is a continuous aperture that surrounds all bolt sizes 22/24/26 without having partitions separating the sections for engaging with the multiple bolts.

In the exemplary embodiment depicted in FIG. 7, the aperture 114 is contoured to engage with the largest bolt head 22 at the top of the aperture 114, a smaller sized bolt head 24 near the middle of the aperture 114, and the smallest bolt head 26 at the bottom of aperture 114. To engage with the bolt head 22/24/26, the user may laterally shift the position of the aperture 114 relative to the bolt head 22/24/26 until the bolt head 22/24/26 is engaged.

FIG. 8 is a bottom view of a heel 110/210 showing a multiple, discrete, hexagonal apertures 112 and 112a spaced along the heel. In an embodiment, aperture 112 is positioned proximal to the pivot point 184, and aperture 112a is positioned distal from the pivot point 186.

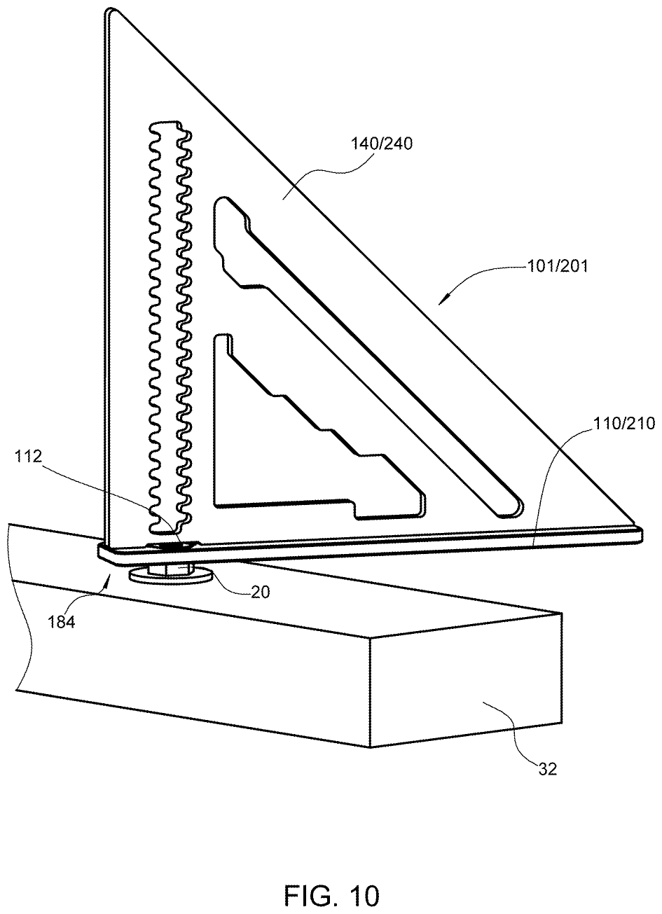

FIGS. 9 and 10 illustrate the use of a rafter square 101/201 in one or more embodiments. FIG. 9 is a perspective view of a rafter square 101/201 having an aperture 112 engaging with a bolt 20 on a circular saw 30 in one or more embodiments. FIG. 10 is a side view of a rafter square 101/201 having an aperture 112 engaging with a bolt 20 on a tool, piece of equipment. or structure.

Although the invention has been discussed with reference to specific embodiments, it is apparent and should be understood that the concept can be otherwise embodied to achieve the advantages discussed. The preferred embodiments above have been described primarily as a rafter square having an integrated tool aperture for tightening and loosening bolts. In this regard, the foregoing description of the rafter square having an integrated tool aperture is presented for purposes of illustration and description. It shall be apparent that other types of equipment would benefit from the aspects of the rafter square with an integrated tool aperture.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A rafter square comprising:
an isosceles right triangular-shaped blade having a base side, a perpendicular side perpendicular to the base side; and a hypotenuse side that defines the hypotenuse between the base side and the perpendicular side, the blade having a plurality of threaded holes formed internally in the blade, each threaded hole having an opening at the base side of the blade;
a heel of generally parallelepiped shape with an elongated body having a top face, a bottom face, a front edge, a back edge, and two side edges, the heel coupled to the blade forming a right angle between the blade and the heel, the heel having one or more through-hole apertures for engaging with a fastening mechanism, the heel having a plurality of fastener through-holes positioned to align with the plurality of threaded holes of the blade when blade is attached to the heel; and,
a plurality of fasteners for releasably attaching the heel to the blade where the top face is positioned immediately adjacent to base side of the blade, each fastener placed through each of the fastener through-holes of the heel and the corresponding threaded hole formed in the blade.

2. The rafter square of claim 1, wherein:
the fastening mechanism comprises a hexagonal bolt; and
the one or more through-hole apertures comprises a hexagonal-shaped aperture sized to releasable receive and engage with the hexagonal bolt.

3. The rafter square of claim 2, wherein the aperture is located on the heel proximal to the back edge of the heel.

4. The rafter square of claim 1, wherein:
the fastening mechanism comprises a hexagonal bolt; and
the one or more through-hole apertures comprises an elongated and stepped continuous aperture to receive and engage with different sized hexagonal bolts.

5. The rafter square of claim 1, wherein the one or more through-hole apertures comprises a plurality of discrete apertures spaced apart on the heel.

6. The rafter square of claim 1, wherein the blade further comprises a blade notch positioned immediately above the aperture in the heel for receiving a head of the fastening mechanism.

7. The rafter square of claim 1, wherein the rafter square is sized to enable the engagement of a bolt securing a circular saw blade to a circular saw.

8. The rafter square of claim 1, where the heel is coupled to the blade via a plurality of fastening screws.

9. A rafter square comprising:
a triangular-shaped blade having a base side, a perpendicular side perpendicular to the base side, and a hypotenuse side that define the hypotenuse between the base side and the perpendicular side; and,
a heel of generally parallelepiped shape with an elongated body having a top face, a bottom face, a front edge, a back edge, and two side edges, the heel coupled to the blade forming a right angle between the blade and the heel, the heel having one or more through-hole apertures for engaging with a fastening mechanism.

10. The rafter square of claim 9, wherein:
the fastening mechanism comprises a hexagonal bolt; and
the one or more through-hole apertures comprises a hexagonal-shaped aperture sized to releasable receive and engage with the hexagonal bolt.

11. The rafter square of claim 10, wherein the aperture is located on the heel proximal to the vertex of the blade opposite the hypotenuse side.

12. The rafter square of claim 9, wherein:
the fastening mechanism comprises a hexagonal bolt; and
the one or more through-hole apertures comprises an elongated and stepped continuous aperture to receive and engage with different sized hexagonal bolts.

13. The rafter square of claim 9, wherein the one or more through-hole apertures comprises a plurality of apertures spaced apart on the heel.

14. The rafter square of claim 10, wherein the blade further comprises a blade notch positioned immediately above the aperture in the heel for receiving the head of the fastening mechanism.

15. The rafter square 101 of claim 9, where the heel is coupled to the blade via a plurality of fastening screws.

16. The rafter square of claim 9, wherein the heel and the blade are formed as a single piece.

17. The rafter square of claim 9, further comprising a level vial aligned parallel with the length of the heel providing visual indication of whether the rafter square is level.

18. A rafter square comprising:
a blade; and,
a heel of generally parallelepiped shape with an elongated body having a top face, a bottom face, a front edge, a back edge, and two side edges, the heel coupled to the blade forming a right angle between the blade and the heel, the heel having one or more through-hole apertures for engaging with a fastening mechanism.

19. The rafter square of claim 18, wherein
the fastening mechanism comprises a hexagonal bolt; and
the one or more through-hole apertures comprises hexagonal-shaped aperture sized to releasable receive and engage with a hexagonal bolt.

20. The rafter square of claim 18, wherein
the fastening mechanism comprises a hexagonal bolt; and
the one or more through-hole apertures comprises an elongated and stepped continuous aperture to receive and engage with different sized hexagonal bolts.
